(19) United States
(12) Patent Application Publication
(10) Pub. No.: US 2004/0076363 A1
(43) Pub. Date: Apr. 22, 2004

(54) Optical switch with increased operational stability

(76) Inventors: Dale W. Schroeder, Scotts Valley, CA (US); John J. Uebbing, Palo Alto, CA (US)

Correspondence Address: AGILENT TECHNOLOGIES, INC., Legal Department, DL429, Intellectual Property Administration, P. O. Box 7599, Loveland, CO, 80537-0599, US

(21) Appl. No.: 10/272,180

(22) Filed: Oct. 16, 2002

(51) Int. Cl. G02B 6/26; G02B 6/42

(52) U.S. Cl. 385/16

(57) ABSTRACT

The optical switch operates in two stages. In the first stage, the bubble is “blown” into the trench by either sidewall heaters or a dedicated central heater. In the second stage, the sidewalls are heated to achieve a dry wall condition by improving the thermal transfer path from the heat source to the reflecting wall. The sidewall heaters are positioned such that there is an indirect thermal path to the sidewalls of the trench. This results in a switch that is more stable, energy efficient, and has a longer mean time to failure.

### BACKGROUND

Prior art optical switches, such as that disclosed by Fouquet, et al. in U.S. Pat. No. 5,699,462, assigned to Agilent Technologies, operate by the principle of total internal reflection. Two arrays of parallel optical waveguides fabricated in the plane of a transparent dielectric sheet are arranged in a crossing pattern. This sheet is called the PLC. A vertical cavity or “trench” is formed at each cross point with a wall oriented such that when the cavity is empty of fluid, light traveling in one waveguide is transferred to the crossing waveguide by total internal reflection. When a cavity is filled with a fluid having an optical index matching that of the waveguide light passes directly across the trench, re-entering and continuing in the original waveguide without appreciable loss. By this means, light is switched between the continuing waveguide and a crossing waveguide by transferring fluid into or out of the associated trench.

As shown in FIG. 1, fluid transfer is accomplished by heating the fluid with an electrical resistor to generate a bubble within the trench. Heaters are fabricated in an array on a silicon substrate that is positioned parallel to and in alignment with the trench array, separated from it by a narrow gap. This substrate is referred to as the MCC. Hence, a heater is positioned opposite the mouth of each trench. Applying an electrical current to a heater causes nearby fluid to evaporate to form a vapor bubble that expands into the trench, displacing the fluid there and causing light to reflect between crossing channels.

### SUMMARY

This novel optical switch has perimeter heaters that operate in two stages. In the “wet” mode, the bubble is “blown” into the trench. In the “dry” stage, the sidewalls are heated to achieve a dry wall condition by improving the thermal transfer path from the heat source to the reflecting wall. An indirect thermal path is created as the separate side heaters are placed proximate to the sidewalls. The switch has increased stability, improved energy efficiency, and a longer mean time to failure.

The optical switch includes a planar waveguide substrate and a heater substrate. The planar waveguide substrate is an array of intersecting waveguide segments. At each cross point, a trench is etched so that an input segment of the first waveguide is aligned for transmission to an output segment of the same waveguide, while an input segment of the second waveguide is aligned for transmission to an output segment of the second waveguide. A heater substrate is formed on a silicon substrate that has a bondable top layer. The heater substrate is arranged such that at each cross point, there is at least one perimeter heater. The layers of the heater substrate may optionally include active control electronics.

### BRIEF DESCRIPTION OF THE DRAWINGS

FIG. 1 illustrates an optical switch of the prior art.

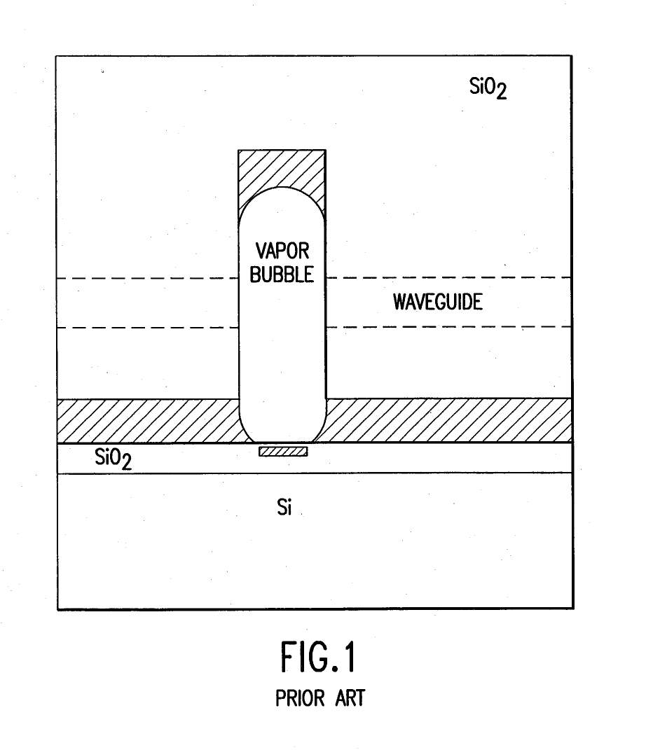

FIGS. 2A-B illustrates an embodiment of the present invention.

FIG. 3 illustrates an alternate embodiment of the optical switch.

FIG. 4 illustrates a flowchart corresponding to the operation of the optical switch.

### DETAILED DESCRIPTION

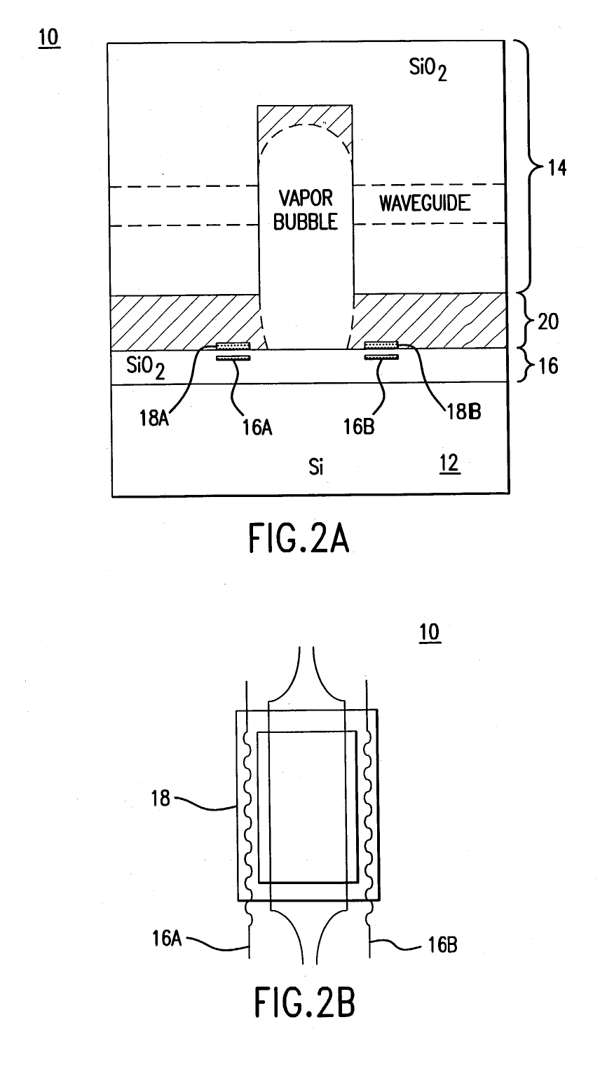

FIGS. 2A-B illustrate an embodiment of the present invention. FIG. 2A illustrates a cross-sectional view while FIG. 2B illustrates a plan view. An optical switch 10 is shown as being formed on a substrate 12. The substrate 12 is preferably silicon, but other materials, e.g. SiO₂, Si₃N₄, SiC, Al₂O₃, SOI wafers, and quartz. The advantages of silicon substrate is that it facilitates the use of integrated circuit fabrication techniques to form the optical switch, and it can be etched through to form channels for fluid flow perpendicular to the plane of the substrate.

The optical switch 10 includes a planar waveguide 14 defined by a lower cladding layer, a core, and an upper cladding layer (not shown). During fabrication, a core layer of material is deposited and etched to form two intersecting waveguides or a cross point.

The ends of the waveguide segments intersect at the gap. The switch 10 is a single switching element in an array of switches. The trench is etched so that an input segment of the first waveguide is aligned for transmission to an output segment of the same waveguide, while an input segment of the second waveguide is aligned for transmission to an output segment of the second waveguide.

A heater substrate 16 is formed on a silicon substrate 12. The heater substrate 16 is arranged such that at each cross point, there at least one perimeter heater 16A, 16B. The layers of the heater substrate 16 may optionally include active control electronics (not shown). The waveguide pattern 14 is aligned face to face with the heater substrate 16 to form a plenum 20. The plenum 20 is filled with fluid. The switch element is connected to the fluid pressure control apparatus, optical fibers, and temperature control apparatus.

The trenches are opened by removing the bulk of the substrate thickness, e.g. chemical machine polishing, etching (wet or dry), laser etching, or laser ablation.

The fluid is optically matched fluid to the index of refraction of the waveguides and that of the PLC. Its volatility determines the amount of power and the nucleation temperature and determines the differential pressure. Preferred fluids include e.g. organic solvents such as 2-fluorotoluene and fluorobenzene.

Optional conductive pads 18A and 18B may be positioned above the side heaters to enhance the indirect thermal transfer path. The pads may be made of solder, silver, gold, composites of solder, composites of gold, composites of silver, alloys of solder, alloys of gold, and alloys of silver. As shown in FIG. 2B, a single conductive pad 18 may be used that corresponds to the perimeter of the trench.

The side heaters 16A, 16b have two functions. In the “wet” mode, the bubble is “blown” or nucleated into the trench. In the “dry” stage, the sidewalls are heated to achieve a dry wall condition by improving the thermal transfer path from the heat source to the reflecting wall. Separate side heaters are placed proximate to a direct thermal path to the sidewalls. This results in a switch that is more stable, energy efficient, and has a longer mean time to failure.

The side heaters 16A, 16B transmit heat through an indirect thermal path to dry the sidewalls. Heat is transmitted heat across a liquid to the sidewalls on the waveguide substrate. The side heaters 16A, 16B are constructed on the silicon substrate. The heaters are operated at a power 5-20 mW each to maintain a pressure within the bubble that dries the sidewalls without generating condensation. The temperature of the wall must be hotter than the temperature of the vapor in the bubble. With one heater, 10-40 mW of total power applied. The selected holding power depends upon the pressure to be maintained. Pressure depends upon the liquid and air concentration within the liquid.

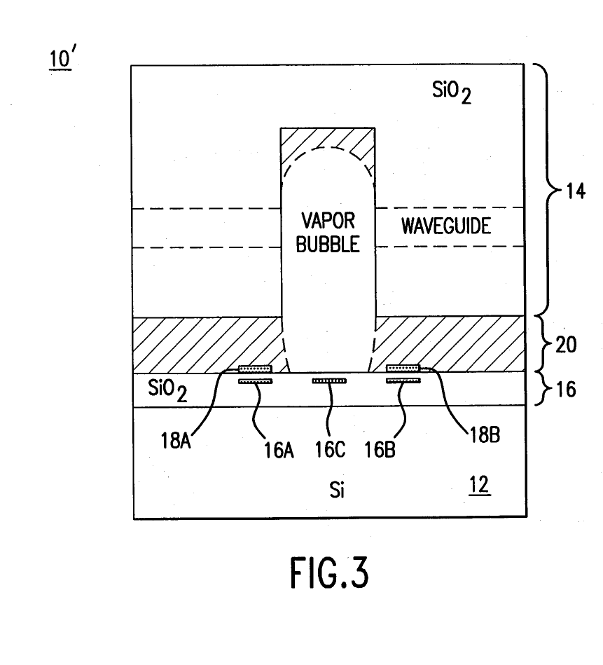

FIG. 3 illustrates another embodiment of the optical switch 10′. When contrasted to FIGS. 2A-B, a dedicated central heater 16C has been included. The central heater 16C is solely used for the nucleation of the bubble.

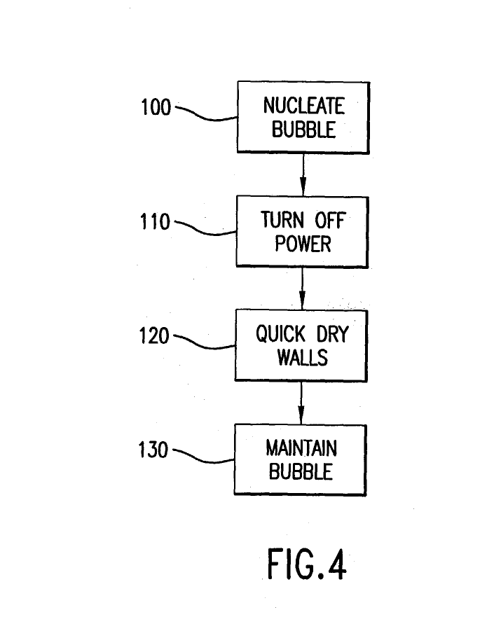

FIG. 4 illustrates a flowchart corresponding to the operation of the optical switch. In step 100, a bubble is nucleated, e.g. 180 mW of power is applied for 100 microseconds. A “wet” bubble is formed as there is liquid between the side heaters and the sidewalls. In step 110, power is turned off to allow the heaters to cool off, e.g. no power is applied for 50 microseconds. Step 110 is optional for the embodiment shown in FIG. 3. In step 120, a “quick drying” power is applied to quickly heat and dry the sidewalls before the bubble collapses, e.g. 80 mW for 5 milliseconds. In step 130, the power is lowered to a predetermined “HOLD” setting to maintain a “dry” bubble.

In operation, the stability of the bubble is enhanced when the walls of the trench are dry. This condition can be described by the following equation:

$${P}_{v} ( T ) = {P}_{o} {ⅇ}^{\frac{- {H}_{f g}}{{R}_{g} T}} \qquad Equation 1$$

Pᵥ(T) is the vapor pressure of the bubble at a selected temperature. Pₒ is the initial pressure. R_{g} is the gas constant. H_{fg} is the enthalpy of the fluid in the gap.

The required pressure range is described by the following equation:

$$\frac{2 σ}{{w}_{G}} > {P}_{BUB} - {P}_{HT} > \frac{2 σ}{{w}_{T}} \qquad Equation 2$$

The difference in pressure is defined by the differential between the bubble pressure P_{BUB} and the hot tub pressure P_{HT}. σ is the surface tension of the fluid. w_{G} is the width of the gap while w_{T} is the width of the trench. A typical range of pressure differences would be 3500 to 9000 Pascals. The higher pressure difference will push a bubble into the gap (Wg) and a lower pressure difference into the trench (Wt).

We claim:

1. A switching element for use along an optical path comprising:
a waveguide substrate having at least two optical waveguide segments on a first surface, including first and second waveguide segments having trenches etched so that the ends intersect at a cross point, the first and second waveguide segments being in fixed relation and generally parallel to the first surface;
a heater substrate positioned above the waveguide substrate such that a side heater is positioned at a side of the cross point, the sidewall heater being operative to dry the walls during switching operation;
the cross point having a trench with parallel walls;
a plenum interposing the waveguide substrate and the heater substrate; and
a liquid disposable within the plenum and the trench, the liquid being responsive to the side heater, wherein optical transmission from the first waveguide segment to the second waveguide segment is determined by a bubble within the trench.

2. An optical switch, as defined in claim 1, a conductive pad positioned above each sidewall heater.

3. An optical switch, as defined in claim 2, wherein the conductive pads are selected from a group that includes solder, silver, gold, composites of solder, composites of gold, composites of silver, alloys of solder, alloys of gold, and alloys of silver.

4. An optical switch, as defined in claim 1, wherein the liquid is a organic solvent having an index of refraction matched to an index of refraction of the waveguides.

5. An optical switch, as defined in claim 4, wherein the organic solvent is selected from a group that includes 2-fluorotoluene and fluorobenzene.

6. An optical switch, as defined in claim 1, wherein:
the heater substrate further including a nucleating heater, positioned within a cross point, operative to nucleate the bubble; and
the side heater operative to dry the sidewalls.

7. An optical switch, as defined in claim 6, wherein the liquid is a organic solvent having an index of refraction matched to an index of refraction of the waveguides.

8. An optical switch, as defined in claim 7, wherein the organic solvent is selected from a group that includes 2-fluorotoluene and fluorobenzene.

9. An optical switch, as defined in claim 7, wherein a pressure difference within the bubble varies between 3500 to 9000 Pascals.

10. An optical switch, as defined in claim 1, wherein a pressure difference within the bubble varies between 3500 to 9000 Pascals.

11. A method for operating an optical switch comprising:
applying a first power to nucleate a bubble within a trench of an optical switch; and
applying a second power to dry the walls of an optical switch.

12. A method, as defined in claim 11, wherein applying a second power includes:
applying an intermediate heat to quick dry the walls; and
applying a holding power to maintain the bubble.
